(19) United States
(12) Patent Application Publication
(10) Pub. No.: US 2002/0026381 A1
(43) Pub. Date: Feb. 28, 2002

(54) Content disclosing support system, content disclosing support method and recording medium recording content disclosing support/control program

(76) Inventor: Hiroshi Sasaki, Tokyo (JP)

Correspondence Address: McGinn & Gibb, PLLC, Suite 200, 8321 Old Courthouse Road, Vienna, VA, 22182-3817, US

(21) Appl. No.: 09/933,734

(22) Filed: Aug. 22, 2001

(30) Foreign Application Priority Data
Aug. 23, 2000 (JP) 253208/2000

(51) Int. Cl. G06F 17/60

(52) U.S. Cl. 705/26

(57) ABSTRACT

The present invention contains a content provider terminal for transmitting screen data of photos through a network, a content disclosing support server for registering screen data of photos provided by unspecified number of content providers and making the data available to the public, and a user terminal for accessing and acquiring disclosed screen data of photos through a network on condition that a user pays a prescribed amount of money to a content provider. The content disclosing support server for counts a number of acquired screen data of photos in order to calculate the amount of money to be paid to a content provider. It is preferable that as a general rule, all of the contents provided by content providers are to be registered and disclosed without receiving any artistic or technical evaluation. With this configuration, more chances are offered to creators so that they can directly ask for public evaluation on their contents (works), and thus possible first-class works are prevented from being buried without being disclosed.

### BACKGROUND OF THE INVENTION

The present invention relates to a content disclosing support system, a content disclosing support method and a recording medium recording a content disclosing support-control program, for supporting content creators, for example, by offering the creators chances to disclose (present) various contents.

Description of the Related Art

In general, when creators want to make their own works such as self-taken photos or self-written novels available to the public and then receive public evaluation, they have to submit their works to a publishing company, for instance, asking for publication. Then, the creators are able to make their works available to the public only when responsible people in the publishing company, for instance, make high evaluation of the works and permit their publication.

Regardless of the fact that those who actually evaluate and purchase published works are the consuming public but not responsible people in publishing companies, creators have not been able to make their own works available to the public and receive public evaluation unless they first receive high evaluation from publishing companies and so forth through a strict screening.

Further, those who take photos or write novels as their hobbies have not had an easier way to make their own works available to the public and receive public evaluation, and thus it has been hard for them to receive any evaluation from the public at large.

In this way, there has been a problem that many works which might have enjoyed a good reputation from the consuming public were buried without being disclosed.

### SUMMARY OF THE INVENTION

In view of the foregoing, it is an object of the present invention to resolve the above-mentioned problem and to offer chances for creators to ask for public evaluation of their own works in an easy way.

In order to solve the aforementioned problem, a content disclosing support system of the present invention is characterized in comprising a content providing means (e.g. a content provider terminal 30A) for transmitting created contents provided by content providers through a network, a registering means (e.g. a content disclosing support server 20) for registering contents provided by unspecified number of content providers through the content providing means (which means accepting contents of not only those who belong to a specific organization or have a specific qualification but also general creators), a content disclosing means (e.g. the content disclosing support server 20) for making the contents registered by the content registering means available to the public, a content acquiring means (e.g. a user terminal 50A) for acquiring one or more content(s) at a user's request while the user can access and view the contents disclosed by the content disclosing means through the network on condition that the user pays a prescribed amount of money, and a counting means (e.g. the content disclosing support server 20) for counting a number of contents acquired by the content acquiring means to calculate the amount of money to be paid to the content providers. It is preferable that all of the contents provided by unspecified number of content providers are to be registered by the content registering means and disclosed by the content disclosing means without receiving any artistic or technical evaluation, as a general rule.

With the aforementioned configuration, contents can be easily registered or disclosed without going through any strict screening. Accordingly, more chances are offered to creators so that they can directly ask for public evaluation on their contents (works), and thus possible first-class works are prevented from being buried without being disclosed. Additionally, since acquired contents are to be counted, the amount of money in proportion to the counted number can be paid to a content provider so that the content provider is able to obtain profit in accordance with the popularity of his/her own work. Consequently, it is expected that many contents are registered by many content providers.

Further, in accordance with one of the aspects of the present invention, a content disclosing support system of the present invention comprises a registering means for registering created contents provided by unspecified number of content providers through a network, a content disclosing means for making the contents registered by the content registering means available to the public, a content transmitting means for transmitting one or more content(s) to a user terminal at a user's request while permitting the user to access and view the contents on condition that a prescribed amount of money is paid, and a counting means for counting a number of contents transmitted by the content transmitting means to calculate the amount of money to be paid to the content providers. In this case, it is also preferable that all of the contents provided by unspecified number of content providers are to be registered by the content registering means and disclosed by the content disclosing means without receiving any artistic or technical evaluation, as a general rule.

With the aforementioned configuration, contents can be easily registered or disclosed without having to go through any strict screening. Accordingly, more chances are offered to creators so that they can directly ask for public evaluation on their contents (works), and thus possible first-class works are prevented from being buried without being disclosed. Additionally, since acquired contents are to be counted, the amount of money in proportion to the counted number can be paid to a content provider so that the content provider is able to obtain profit in accordance with the popularity of his/her own work. Consequently, it is expected that many contents are registered by many content providers.

It is preferable that the content disclosing support system of the present invention contains a count number memorizing means (e.g. a database included in the content disclosing support server) for recognizably memorizing the total count number of each content within a specified period of time and the total count number of all contents within the specified period of time, on the basis of the counting result given by the counting means, a specified user number memorizing means (e.g. the database included in the content disclosing support server) for memorizing the number of users who have accepted payment of a set fee (e.g. 300 yen) for the specified period of time, a payment amount deciding means (e.g. the database included in the content disclosing support server) for deciding the amount of money to be paid to each content provider by calculating as follows; divide a part of the total amount of collected money derived on the basis of a user number memorized in the specified user number memorizing means by the total count number of all contents, and multiply the calculated value by the total count number of each content.

With the aforementioned configuration, the amount of money to be paid to each content provider can be decided on the basis of the total count number of each content, the total count number of all contents, and the amount of money collected from the users. For instance, supposing that the amount of money to be paid to each content provider is compiled once in every specified period of time (e.g. one month), the content provider is to be paid the amount of money calculated as follows; divide a part (e.g. 80%) of the total amount of money (e.g. 300 yen×the number of users accepted the payment) collected (or to be collected) from the users within the specified period of time by the total number of downloads with respect to all disclosing contents within the specified period of time, and multiply the calculated value by the total number of downloads with respect to the contents provided by a specific content provider within the specified period of time. Thus, in such system where all contents of a server can be accessed and acquired by making certain payments, the amount of money to be paid to a content provider can be properly decided in proportion to the rate of hit numbers of each content.

In this case, for example, the contents can be picture images such as landscape taken by an image importing device (e.g. a camera device, a digital camera device, a digital video camera device), or writings such as novels and haiku.

With the aforementioned configuration, photos, novels and the like can be easily registered or disclosed without having to go through any strict screening. Thus, more chances are offered to the creators for directly asking for public evaluation on their photos, novels, and so forth.

It is preferable that the system contains a base station which transmits and receives information between subscriber terminals, and the content acquiring means transmits and receives information through the base station.

Since the aforementioned configuration clears the way for accessing and acquiring contents by using a cell phone terminal, contents can be accessed or acquired easily and cheaply. Thus, utilization of the content disclosing service is promoted and it can be expected that contents are evaluated by a lot of users.

Preferably, the user terminal is composed of a cell phone terminal, and the content transmitting means transmits contents to the cell phone terminal.

With the aforementioned configuration, since contents are to be transmitted to a cell phone terminal, a user is able to access and acquire the contents easily and cheaply. Thus, utilization of the content disclosing service is promoted and it can be expected that contents are evaluated by a lot of users.

In accordance with one of the aspects of the present invention, a content disclosing support method of the present invention is characterized in comprising the steps of; transmitting created contents provided by content providers through a network, registering the contents provided by unspecified number of content providers, disclosing the registered contents to the public, accessing the disclosed contents through the network on condition that a prescribed sum of money is paid, acquiring one or more content(s) at a user's request, and counting the number of contents acquired for calculating the amount of money to be paid to the content providers. Preferably, as a general rule, all of the contents provided by content providers are to be registered and disclosed without receiving any artistic or technical evaluation.

With the aforementioned method, contents can be easily registered or disclosed without having to go through any strict screening. Accordingly, more chances are offered to creators so that they can directly ask for public evaluation on their contents (works), and thus possible first-class works are prevented from being buried without being disclosed.

Further, in accordance with one of the aspects of the present invention, a content disclosing support method of the present invention is characterized in comprising the steps of; registering created contents provided by unspecified number of content providers through a network, disclosing the registered contents to the public, permitting to access the contents on condition that a prescribed sum of money is paid, transmitting one or more content(s) to a user terminal through the network at a user's request, and counting the number of contents transmitted to the user terminal in order to calculate the amount of money to be paid to the content providers. Preferably, as a general rule, all of the contents provided by content providers are to be registered and disclosed without receiving any artistic or technical evaluation.

With the aforementioned method, contents can be easily registered or disclosed without having to go through any strict screening. Accordingly, more chances are offered to creators so that they can directly ask for public evaluation on their contents (works), and thus possible first-class works are prevented from being buried without being disclosed.

It is preferable that the amount of money to be paid to the content providers is determined on the basis of a total count number of each content for a fixed period of time and a total count number of all contents for the fixed period of time.

With the aforementioned method, the amount of money to be paid to each content provider can be calculated properly. For instance, supposing that the amount of money to be paid to each content provider is compiled once in every specified period of time (e.g. one month), the content provider is to be paid the amount of money calculated as follows; divide a part (e.g. 80%) of the total amount of money (e.g. 300 yen×the number of users accepted the payment) collected (or to be collected) from the users within the specified period of time by the total number of downloads with respect to all disclosing contents within the specified period of time, and multiply the calculated value by the total number of downloads with respect to the contents provided by a certain content provider within the specified period of time. Thus, in such method where all contents of a server can be accessed and acquired by making certain payments, the amount of money to be paid to a content provider can be properly decided in proportion to the rate of hit numbers of each content.

Preferably, the user terminal is composed of a cell phone terminal, and contents are transmitted to the user terminal through the network and the base station.

With the aforementioned method, since contents can be accessed and acquired by a cell phone terminal, the contents are to be accessed and acquired easily and cheaply. Thus, utilization of the content disclosing service is promoted and it is expected that contents are evaluated by a lot of users.

Further, according to one of the aspects of the present invention a recording medium recording a content disclosing support-control program is provided. The content disclosing support-control program comprises the steps of; registering created contents provided by unspecified number of content providers through a network, disclosing the registered contents to the public, permitting to access the contents on condition that a prescribed sum of money is paid, transmitting one or more content(s) to a user terminal through the network at a user's request, and counting the number of contents transmitted to the user terminal in order to calculate the amount of money to be paid to the content providers. Preferably, as a general rule, all of the contents provided by content providers are to be registered and disclosed without receiving any artistic or technical evaluation.

With the aforementioned configuration, the contents can be easily registered or disclosed without going through any strict screening. Accordingly, more chances are offered to creators so that they can directly ask for public evaluation on their contents (works), and thus possible first-class works are prevented from being buried without being disclosed.

### BRIEF DESCRIPTION OF THE DRAWINGS

The objects and features of the present invention will become more apparent from the consideration of the following detailed description taken in conjunction with the accompanying drawings in which:

FIG. 1 is a block diagram showing an example of a configuration of a content disclosing support system according to one embodiment of the present invention;

FIG. 2 is a flow chart showing an example of a content provider registration process according to the embodiment of the present invention;

FIG. 3A is an explanation drawing showing an example of a content provider registering screen according to the embodiment of the present invention;

FIG. 3B is an explanation drawing showing an example of a content provider registration results notifying screen according to the embodiment of the present invention;

FIG. 4 is a flow chart showing an example of a content registration process according to the embodiment of the present invention;

FIG. 5 is an explanation drawing showing an example of a content registering screen according to the embodiment of the present invention;

FIG. 6 is a flow chart showing an example of a content registration process according to the embodiment of the present invention;

FIG. 7 is an explanation drawing showing an example of a front page in case of executing a content acquiring process according to the embodiment of the present invention;

FIG. 8 is an explanation drawing showing an example of a selection menu screen for a graphic download according to the embodiment of the present invention;

FIG. 9 is an explanation drawing showing an example of a selection menu screen for downloading graphics of mountains and rivers according to the embodiment of the present invention;

FIG. 10 is an explanation drawing showing an example of a selection menu screen of latest graphics according to the embodiment of the present invention; and

FIG. 11 is an explanation drawing showing an example of a screen in case that contents are acquired according to the embodiment of the present invention.

### DESCRIPTION OF THE PREFERRED EMBODIMENTS

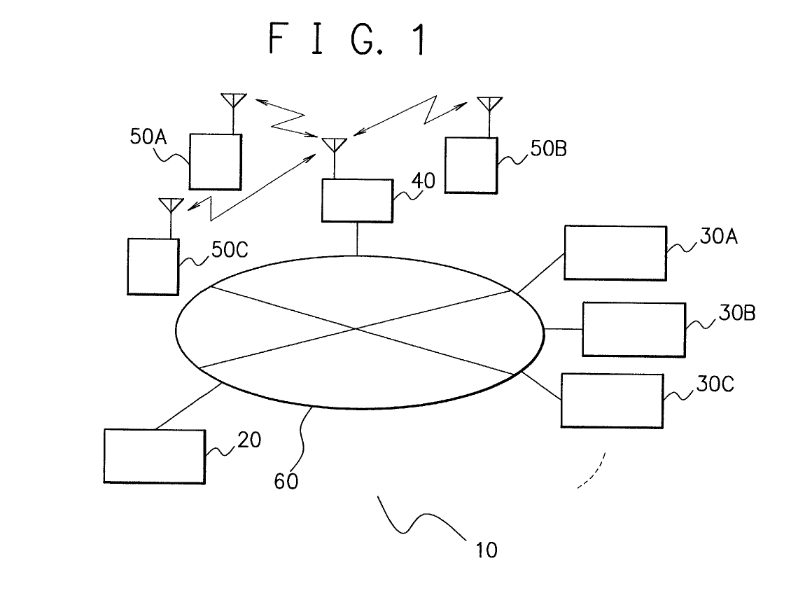

A description is given of one embodiment of the present invention with reference to the accompanying drawings. FIG. 1 is a block diagram showing an example of a configuration of a content disclosing support system 10 in the embodiment of the present invention.

A content disclosing/publishing support system 10 comprises a content disclosing support server 20, content provider terminals 30A to 30C, a base station 40 and user terminals 50A to 50C. The content disclosing support server 20, the content provider terminals 30A to 30C and the base station 40 are respectively connected to a network 60 (e.g. an internet, a common carrier leased line, a public circuit, a wireless communication line). The user terminals 50A to 50C are configured to be accessible to the network 60 via the base station 40. Incidentally, any number of content provider terminals, base stations and user terminals can be provided.

The content disclosing support server 20 is composed of an information processing equipment such as a work station server. The content disclosing support server 20 having a function of a WWW (World Wide Web) server, for example, provides a homepage for accepting contents from content providers or disclosing contents to the public.

Further, the content disclosing support server 20 is provided with a database (not shown) for memorizing registration information on content providers, a database for memorizing registered (or provisionally registered) contents and a database for memorizing the download number (the hit number) of contents.

The content provider terminals 30A to 30C are composed of an information processing equipment such as a personal computer, and are respectively managed by content providers (e.g. content creators). The content provider terminals 30A to 30C in this embodiment have a browser being incorporated, for instance, and have an environment (e.g. a system environment relating to hardware, software, provider contract and so on) where they are capable of accessing the content disclosing support server 20 through the network 60.

The base station 40 transmits and receives information using radio signals between subscriber terminals such as user terminals 50A to 50C.

In this embodiment of the present invention, the user terminals 50A to 50C are structured with cell phone terminals having an environment where they are capable of accessing the content disclosing support server 20 via the network 60. The user terminals 50A to 50C, according to the user's operation (e.g. a designated operation of URL (Uniform Resource Locator)), are able to access a homepage provided by the content disclosing support server 20, and browse a homepage by use of an incorporated browser.

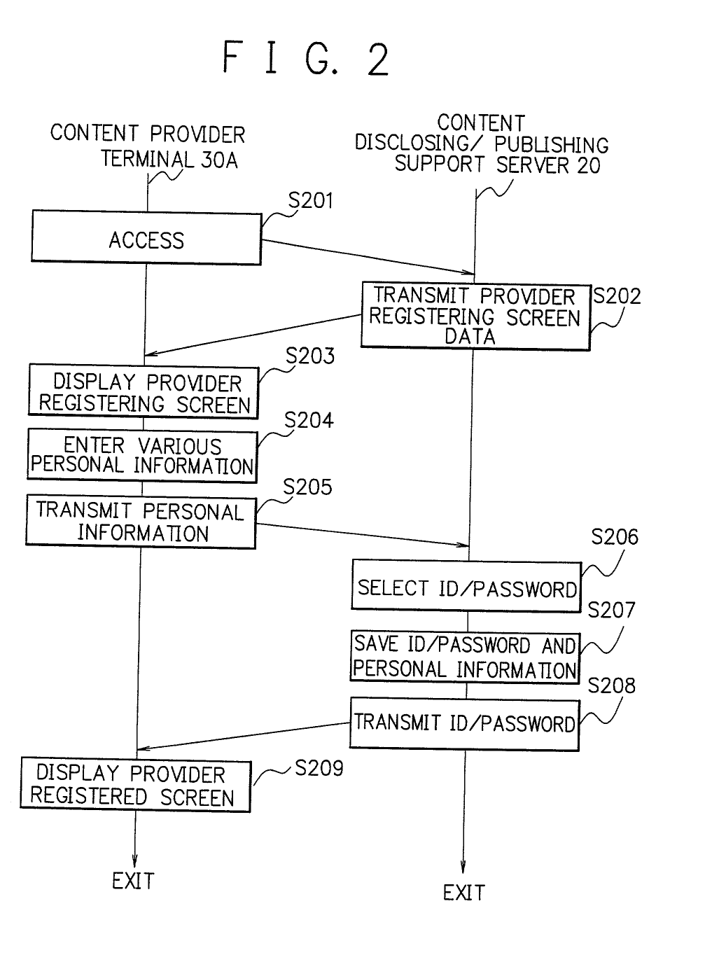

Next, an explanation will be given on a registration process of content providers in the content disclosing support system 10 according to the embodiment of the present invention. FIG. 2 is a flow chart showing an example of the content provider registration process. In this embodiment, an explanation will be given on the process in case that a content provider X managing a content provider terminal 30A attempts to register himself/herself in the content disclosing support server 20 as a content provider.

First of all, the content provider terminal 30A, following the operation of the content provider X, accesses a homepage provided by the content disclosing support server 20 via the network 60 (Step S201), and requests for provider registering screen data. Accordingly, the content disclosing support server 20 transmits the provider registering screen data (Step S202). When the content provider terminal 30A acquires the provider registering screen data, it displays the provider registering screen on a display screen so that items necessitated for registration of a content provider can be entered (Step S203).

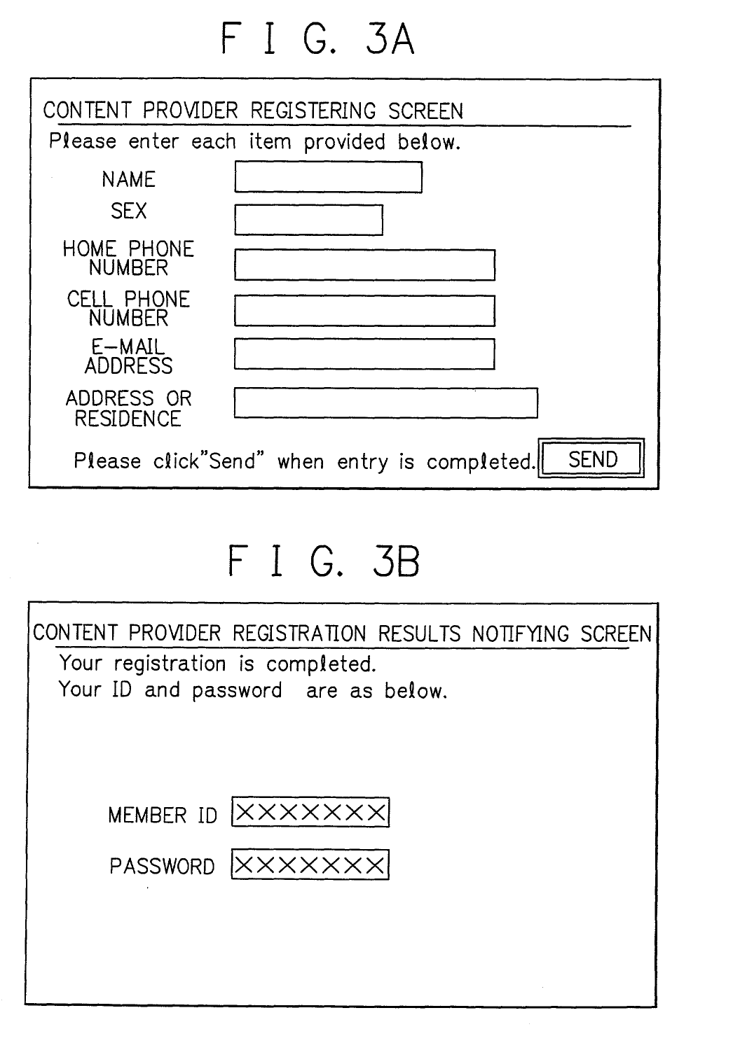

As shown in FIG. 3A, a provider registering screen is provided with spaces for entering personal information such as name, sex, phone number (phone number at home), cell phone number, e-mail address, home address, etc.

As various personal information is entered through the operation by the content provider X (Step S204), and when the content provider X hits the send button displayed on the display screen, the content provider terminal 30A transmits the personal information being entered to the content disclosing support server 20 via the network 60 (Step S205).

Upon receiving various personal information, the content disclosing support server 20 confirms that required information is being entered, and then decides a member ID, a password, and so forth, which are to be granted to the content provider X (Step S206). Then the content disclosing support server 20 stores the decided member ID, password and various personal information in its database (Step S207). Then, the content disclosing support server 20 transmits the provider registering screen data including the ID and password to the content provider terminal 30A through the network 60 (Step S208). Here, the password can be decided by the content provider X. Furthermore, the member ID and password can be mailed to the content provider X.

When the content provider terminal 30A receives the provider registering screen data via the network 60, it displays the provider registering screen data including the member ID and password on the display screen (Step S209) as shown in FIG. 3B, and notifies the content provider X of completion of the registration process.

In this way, when the member ID and password are granted to the content provider X, and as the member ID, password and various personal information of the content provider X are registered, the content provider registration process of this embodiment is completed.

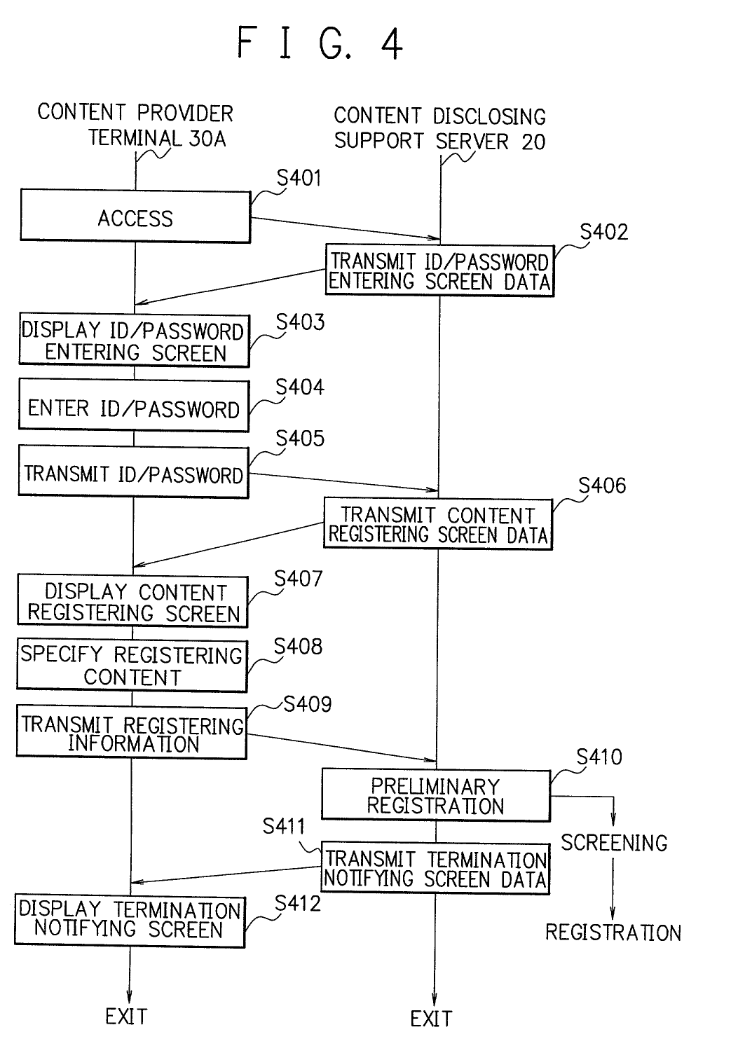

Next, an explanation will be given on a content registration process in the content disclosing support system 10 of this embodiment. FIG. 4 is a flow chart showing an example of a content registration process. In the following, an explanation will be given on a process of the case that the content provider X who has completed the provider registration in advance attempts to register self-taken image data (contents) to the content disclosing support server 20.

First of all, the content provider terminal 30A, following the operation by the content provider X, accesses a homepage provided by the content disclosing support server 20 via the network 60 (Step S401), and requests for entering screen data for entering member ID and password. Then, upon request, the content disclosing support server 20 transmits the entering screen data for entering member ID and password (Step S402). When the content provider terminal 30A receives the entering screen data for entering member ID and password, it displays a corresponding entering screen on the display screen for the member ID and password to be entered (Step S403).

Thereafter, the content provider X operates input units (not shown) such as a keyboard or a mouse at the content provider terminal 30A, and thus the member ID and password having been granted to the content provider X are entered in the entering spaces of the entering screen (Step S404). Then, the content provider terminal 30A, following the operation by the content provider X, transmits the member ID and password to the content disclosing support server 20 (Step S405).

After the content disclosing support server 20 certificates the content provider on the basis of the entered member ID and password, it transmits content registering screen data to the content provider terminal 30A (Step S406).

Once the content registering screen data is entered, the content provider terminal 30A displays a corresponding content registering screen on the display screen for entering a content which is to be registered (Step S407).

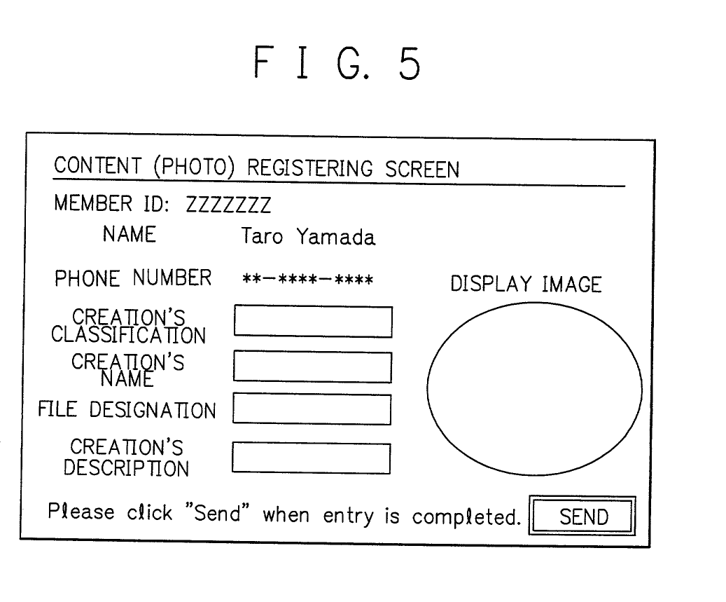

As shown in FIG. 5, the content registering screen is provided with a display space for displaying information about a content provider such as name, an entering space for entering classification and name of a content, an entering space for entering a file name storing the content, a display space for displaying the content image stored in a designated file and a send button which is hit when transmitting the content to be registered.

When the content registering screen is displayed, the content provider X enters content classification, content name and so forth in each entering space, and specifies a storing place of the content to be registered by entering a name of a file where the content is stored (Step S408). Incidentally, in this embodiment, when the content provider X specifies the file where the content is stored, the content provider terminal 30A displays the content to be registered in a designated display space so that the content provider X can confirm the content.

When the name of the file storing the content is entered, and the content provider X instructs transmission of the entered information such as the content, the content provider terminal 30A transmits various registration information such as the content (the file where the content is stored) to the content disclosing support server 20 via the network 60 (Step S409).

When the content disclosing support server 20 receives the registration information such as the content, it executes a preliminary registration of the content by storing the entered information in a database managed by the content disclosing support server 20 (Step S410). According to this embodiment, a preliminary registration is conducted to officially register a content following a simple screening after the preliminary registration. Only after the official registration the content can be accessed by the public.

The screening for determining the official registration is executed, for example, by an administrator of the content disclosing support server 20. The screening is conducted for the purpose of eliminating such works which include expressions defaming or backbiting a specific target, which include obscene expressions or which are being obviously plagiarized from other works, thus preventing those works from being disclosed to the public. In this embodiment, basically all of the works are disclosed to the public so that possible first-class works are prevented from being buried without being disclosed. Thus, an artistic or technical evaluation is not conducted in this screening process.

When the registering information on the received contents is preliminary registered, the content disclosing support server 20 transmits data notifying termination of registration to the content provider terminal 30A (Step S411).

When this data notifying termination of registration is received, the content provider terminal 30A displays a message on the display screen notifying completion of registration (Step S412). Here, depending on the expressions of a content, a written instruction can be displayed announcing that the content cannot be officially registered.

In a database of the content disclosing support server 20, the content (an image data of a photo in this embodiment) is registered together with a corresponding classification of the creation (e.g. classification of shooting object such as mountains, rivers, buildings, schools, vehicles, animals etc.). In this way, the database of the content disclosing support server 20 contains registered information classified by the types of creations, which can be extracted. Additionally, such accompanying information as registration date, for instance, is also registered in the database of the content disclosing support server 20.

As described above, when the content is registered in the database of the content disclosing support server 20, the content registration process of this embodiment is completed.

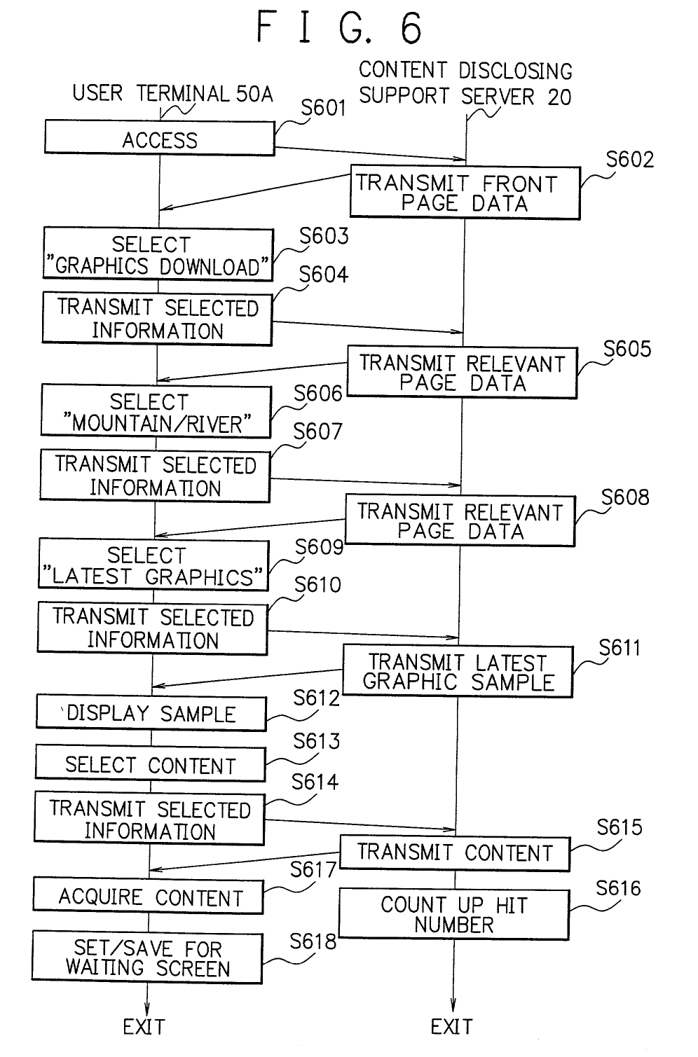

Next, an explanation will be given on a content disclosing process in the content disclosing support system 10 of this embodiment. FIG. 6 is a flow chart showing an example of the content disclosing process according to this embodiment. In this embodiment, an explanation will be given on the case that a user Y operating the user terminal 50A acquires a content disclosed by the content disclosing support server 20.

Further, the administrator of the content disclosing support system, who operates the homepage for disclosing contents, promotes the homepage established, by direct mails or advertisements, for example, for the sake of encouraging the service usage. Thus, information on creations becomes available to the public more effectively than the case that each creator individually advertises his/her own creation.

In the content acquiring process, first of all, the user terminal 50A, following the operation by the user Y (including an operation such as specifying URL), accesses a homepage provided by the content disclosing support server 20 via the base station 40 and the network 60 (Step S601), and requests for transmission of front page data. Then, the content disclosing support server 20 transmits the front page data (Step S602). When the user terminal 50A acquires the front page data, it displays the front page of the homepage on the display screen (Step S603).

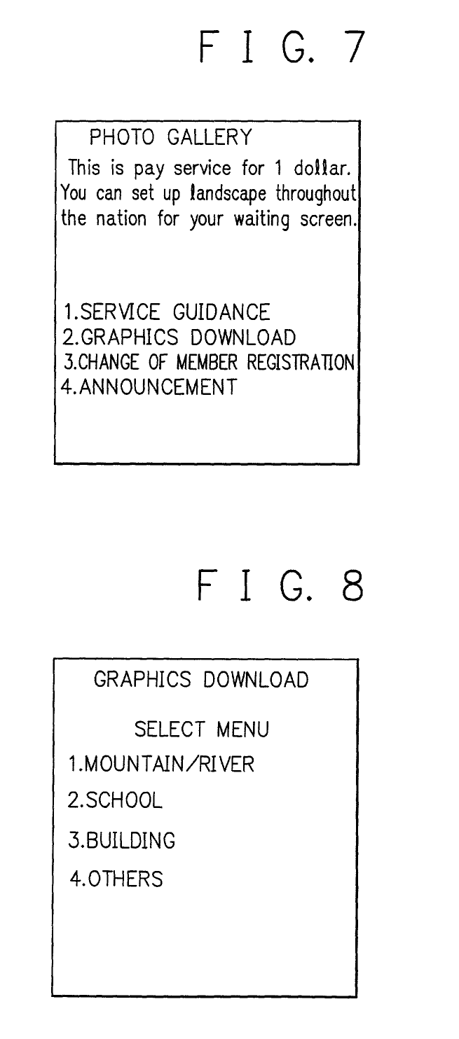

This front page, as shown in FIG. 7 for example, includes a display area displaying an introduction on the contents of the homepage provided by the content disclosing support server 20. The display area displays a variety of select menus such as “1. Service Guidance” for confirming a detailed service content, “2. Graphics Download” for acquiring a content, “3. Change of Member Registration” for changing a registration particulars such as phone number and address in case of a membership system, which will be described later on, and “4. Announcement” for accessing to announcement about the service.

In this embodiment, a user who wants to access and acquire a content is charged one dollar, for example, as a pseudo-entrance fee (in this embodiment, a configuration can be arranged so that a user is able to acquire as many contents as he/she wants once the user pays the entrance fee). Additionally, a membership system wherein membership is registered in advance can be applied so that a user is able to make as many pseudo-entrances as he/she wants per month and then acquire contents once the user pays one dollar, for example.

Further, in general, comparing with a homepage browsed by a personal computer and such, a homepage capable of being browsed by a cell phone would usually have some restrictions with respect to a screen size, a color, a font, a memory size and the like. In this embodiment, the content disclosing support server 20 is constructed to provide a homepage created under designated restrictions, so that a homepage is able to be browsed by the user terminal 30A composed of a cell phone.

In this embodiment, for instance, when the front page of the homepage is displayed and “2. Graphics Download” of a select menu is selected (Step S603), the user terminal 50A notifies the content disclosing support server 20 that “2. Graphics Download” is being selected (Step S604). Then the content disclosing support server 20 transmits screen data of the select menu displayed according to the selection of “2. Graphics Download” (Step S605). In this embodiment for example, when the user terminal 50A receives the screen data, it displays a corresponding select menu screen on the display screen for the user to be able to select among classifications of graphics which can be downloaded.

The select menu screen of graphic classifications, as shown in FIG. 8, is provided with a display area for each select menu including “1. Mountain/River” for selecting graphics of mountains, rivers, etc., “2. School” for selecting graphics of school buildings, schoolyards, etc., “3. Building” for selecting skyscrapers, bridges, etc., and “4. Others” for selecting other graphics.

In this embodiment, for example, when the select menu screen of graphic classifications is displayed, and “2. Mountain/River” of the select menu is selected (Step S606), the user terminal 50A notifies the content disclosing support server 20 that “2. Mountain/River” is being selected (Step S607). Then, the content disclosing support server 20 transmits screen data of the select menu displayed according to the selection of “2. Mountain/River” (Step S608). When the user terminal 50A receives the screen data, it displays a corresponding select menu screen concerning graphics of mountains and rivers, which can be downloaded, on the display screen.

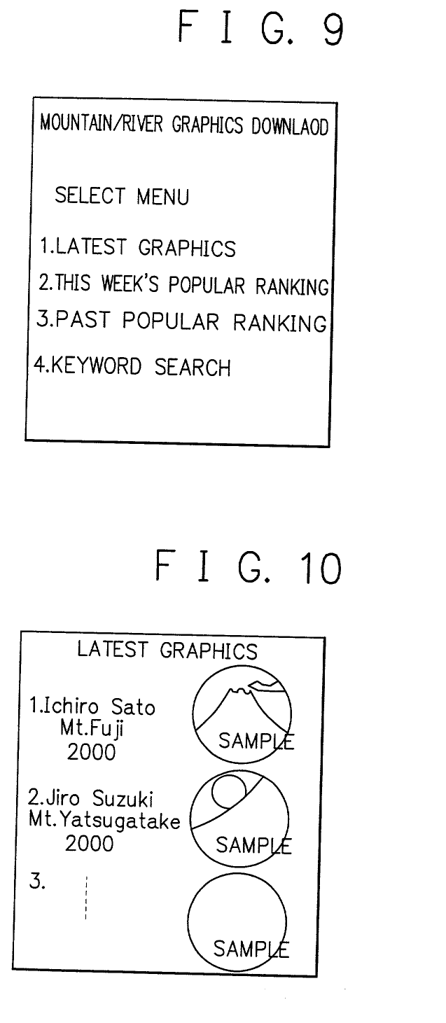

As shown in FIG. 9, the select menu screen of graphics of mountains and rivers, for example, is provided with a display area for each select menu including “1. Latest Graphics” for accessing latest graphics, “2. This Week's Popular Ranking” for accessing recent popular contents, “3. Past Popular Ranking” for accessing popular contents disclosed in the past, and “4. Keyword Search” for searching for a content, using keywords such as creator's names.

In this embodiment, for instance, when the select menu screen concerning graphics of mountains and rivers is displayed, and “1. Latest Graphics” of the select menu is selected (Step S609), the user terminal 50A notifies the content disclosing support server 20 that “1. Latest Graphics” is being selected (Step S610). Then, the content disclosing support server 20 transmits screen data for accessing samples of latest graphics (Step S611). When the user terminal 50A receives the screen data, as shown in FIG. 10 for example, it displays graphic samples concerning mountains and rivers, which have been recently registered, on the display screen (Step S612).

When the graphic samples are displayed, and the user Y selects, for example, “1. Mt. Fuji” out of the samples (Step S613), the user terminal 50A notifies the content disclosing support server 20 that “1. Mt. Fuji” is being selected (Step S614). Then, the content disclosing support server 20 transmits screen data of “1. Mt. Fuji” (in this embodiment, the screen data is for use as a wall paper) (Step S615) and adds one hit for the hit number of “1. Mt. Fuji” (Step S616).

A count value on a hit number of each content is used for calculating the amount of money to be paid to each content provider. For instance, supposing that the count number is to be complied once a month, a content provider is to be paid the amount of money calculated as follows; deduct a service charge for the content disclosing support server (e.g. 20% of the total amount of pseudo-entrance fee) from the total amount of pseudo-entrance fee collected from each user for one month, and divide the calculated value by the total count number of all contents, and then multiply the calculated value by the total count number of a specified content. Thus, the content provider is able to realize the public evaluation for his/her own work, for example, by the amount of money he/she receives. Further, the amount to be paid to the content providers can be calculated, for example, by periodically abstracting registration information (e.g. information on a count number for each content, a number of users responded to payment requests for pseudo-entrance fee, etc.) of the database at the content disclosing support server 20.

If the amount of payment is decided as mentioned above, as the system according to this embodiment provides that all contents disclosed at a homepage provided by the content disclosing support server 20 can be accessed and acquired by making certain amount of payment (not paying for each content, but paying a constant amount as a pseudo-entrance fee), an appropriate (fair) amount of money can be paid to the content providers on the basis of a hit number of each content. In this way, according to this embodiment, in such system where fees can be easily collected from users (because the amount of payment is fixed), an adequate amount of money to be paid to the content providers can be easily calculated.

For example, payment can be made by means of a bank transfer. In this case, an account number should be registered when a provider is registered. Counting results of a hit number of each content and information on payment collected from users are stored in the database of the content disclosing support server 20.

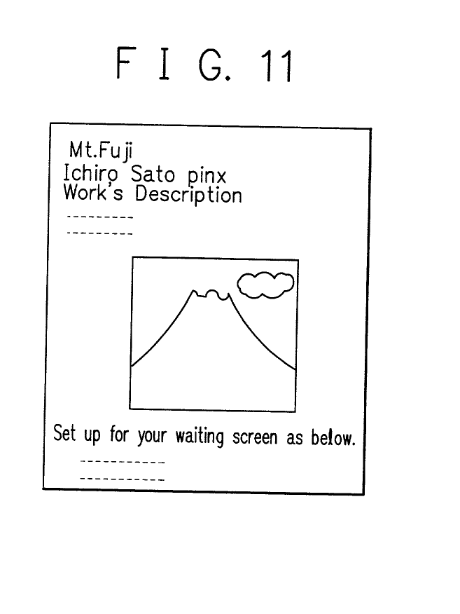

For example, when the user terminal 50A acquires screen data (a content) which the user Y has requested (Step S617), as shown in FIG. 11, a graphic of “1. Mt. Fuji” is displayed. In this embodiment, a setting method for setting the graphic as wall paper for a waiting screen is also displayed.

Thereafter, following the operation by the user Y, the screen data of “1. Mt. Fuji” is registered in a memory area of the user terminal 50A, and then set up as a wall paper through a designated operation when the user requests (Step S618). In case that the user wants to acquire additional contents, the aforementioned processes such as Steps S606 to S617 should be repeated.

When the content disclosing support system 10 in this embodiment finishes reading the content which the user Y has wanted to acquire, it terminates the content acquiring process.

As explained above, by opening the way to register all of the requested contents as a general rule and provide opportunities for disclosing contents to the public (a homepage for disclosing or providing contents), creators are able to directly receive public evaluation for their works without going through any screening by such people who are in charge in publishing companies and so forth. Thus, possible first-class works are prevented from being buried and a consuming public is able to be exposed to various works.

Further, as mentioned above, with the configuration where registered contents are disclosed to the public on condition that a viewer is charged with a designated fee, and money in proportion to a hit number of a content is paid to a content provider, the content provider can gain profit reflecting popularity of the content. In this way, a creator is able to recognize the public evaluation for his/her own work. Additionally, the administrator of the content disclosing support server 20 can earn a maintenance charge (fees such as a promotion fee included) for offering a site.

As described above, with the configuration where a cell phone is employed as the user terminal 50A, it becomes easy to access and acquire contents. Thus, usage of this service can be promoted and many users of the service can be expected. Consequently, creators can expect many users to access their works and receive evaluations on their works from the users.

In the aforementioned embodiment, the explanation has been mainly given on the case that contents are screen data of taken landscape pictures. However, contents can be some taken photos of human beings, animals, paintings and the like. Also, contents can be, for example, document data or graphic data (in case of downloading as graphics) of novels, haiku, etc., or data of computer graphic images, animations, music (e.g. melody signaling an incoming call), etc.

When a novel is disclosed and provided as a content, for example, the administrator of the content disclosing support server arranges a list about the provided contents (e.g. a list can show an outline of a novel for each content). Then, a user accesses the content disclosing support server, accepts payment of a pseudo-entrance fee, and acquires the list of contents and accesses the contents for viewing. After the user accesses the contents, the user selects and downloads his/her favorite content. Thereafter, the user can enjoy reading the acquired content as much as he/she wants by displaying the content saved at the user terminal on a display screen, for example.

With the aforementioned configuration, users are able to enjoy reading various types of novels since they can expect to acquire works which have not been disclosed just because they have not been accepted by publishing companies, etc.

Further, in the aforementioned embodiment, the configuration is made so that a cell phone is employed as the user terminal, but the user terminal can also be an information processing device such as a personal computer. When contents are disclosed or provided using an information processing device as the user terminal, restrictions in terms of a screen size, a color, a font, a memory size, etc. can be largely eliminated. In this way, contents of more subtle images can be disclosed or provided.

Still further, in the aforementioned embodiment, the configuration is made so that an information processing device such as a personal computer is employed as the content provider terminal, but the content provider terminal can be a cell phone as well.

Additionally, the configuration can be modified in the way that a recording medium loading a control program whereby the content disclosing support server 20 carries out each process in the aforementioned embodiment is applied. In this case, the content disclosing support server 20 should load a recording medium recording a control program for carrying out such process as a process of registering content providers, a process of registering contents, a process of offering contents, and so forth, and carry out each process by reading out the control program. In the same way, the configuration can be modified so that a recording medium loading a control program for executing each process to be carried out by the content provider terminals 30A to 30C and user terminals 50A to 50C is applied.

As explained above, in accordance with the present invention, a content disclosing support system of the present invention is characterized in comprising a content providing means for transmitting created contents provided by content providers through a network, a registering means for registering contents provided by unspecified number of content providers through the content providing means, a content disclosing means for making the contents registered by the content registering means available to the public, a content acquiring means for acquiring one or more content(s) at a user's request while the user can accesses and view the contents disclosed by the content disclosing means through the network on condition that the user pays a prescribed amount of money, and a counting means for counting a number of contents acquired by the content acquiring means to calculate the amount of money to be paid to the content providers. Therefore, in accordance with the present invention, contents can be easily registered or disclosed without going through any strict screening. Accordingly, more chances are offered to creators so that they can directly ask for public evaluation on their contents (works), and thus possible first-class works are prevented from being buried without being disclosed. Additionally, since acquired contents are to be counted, the amount of money in proportion to the counted number can be paid to a content provider so that the content provider is able to obtain profit in accordance with the popularity of his/her own work. Consequently, it is expected that many contents are registered by many content providers.

Furthermore, in accordance with the present invention a content disclosing support system comprises a registering means for registering created contents provided by unspecified number of content providers through a network, a content disclosing means for making the contents registered by the content registering means available to the public, a content transmitting means for transmitting one or more content(s) to a user terminal at a user's request while permitting the user to access and view the contents on condition that a prescribed amount of money is paid, and a counting means for counting a number of contents transmitted by the content transmitting means to calculate the amount of money to be paid to the content providers. Therefore, in accordance with the present invention, contents can be easily registered or disclosed without having to go through any strict screening. Accordingly, more chances are offered to creators so that they can directly ask for public evaluation on their contents (works), and thus possible first-class works are prevented from being buried without being disclosed.

The content disclosing support system of the present invention may be provided with a count number memorizing means for recognizably memorizing the total count number of each content within a specified period of time and the total count number of all contents within the specified period of time, on the basis of the counting result given by the counting means, a specified user number memorizing means for memorizing the number of users who have accepted payment of a set fee for the specified period of time, a payment amount deciding means for deciding the amount of money to be paid to each content provider by calculating as follows; divide a part of the total amount of collected money derived on the basis of a user number memorized in the specified user number memorizing means by the total count number of all contents, and multiply the calculated value by the total count number of each content. In this case, the amount of money to be paid to each content provider can be decided on the basis of the total count number of each content, the total count number of all contents, and the amount of money collected from the users. Thus, in such system where all contents of a server can be accessed and acquired by making certain payments, the amount of money to be paid to a content provider can be properly decided in proportion to the rate of hit numbers of each content.

In the content disclosing support system of the present invention, for example, the contents can be picture images such as landscape taken by an image importing device, or writings such as novels and haiku. In this case, photos, novels and the like can be easily registered or disclosed without having to go through any strict screening. Thus, more chances are offered to the creators for directly asking for public evaluation on their photos, novels, and so forth.

In the content disclosing support system of the present invention, the system may be provided with a base station which transmits and receives information between subscriber terminals, and the content acquiring means may be provided for transmitting and receiving information through the base station. In this case, since contents can be accessed and acquired using a cell phone terminal, the contents can be accessed or acquired easily and cheaply. Thus, utilization of the content disclosing service is promoted and it can be expected that contents are evaluated by a lot of users.

In the content disclosing support system of the present invention, the user terminal may be composed of a cell phone terminal, and the content transmitting means may be provided for transmitting contents to the cell phone terminal. In this case, since contents can be transmitted to a cell phone terminal, a user is able to access and acquire the contents easily and cheaply. Thus, utilization of the content disclosing service is promoted and it can be expected that contents are evaluated by a lot of users.

Furthermore, in accordance with the present invention, a content disclosing support method of the present invention is characterized in comprising the steps of; transmitting created contents provided by content providers through a network, registering the contents provided by the unspecified number of content providers, disclosing the registered contents to the public, accessing the disclosed contents through the network on condition that a prescribed sum of money is paid, acquiring one or more content(s) at a user's request, and counting the number of contents acquired for calculating the amount of money to be paid to the content providers. Therefore, in accordance with the present invention, contents can be easily registered or disclosed without having to go through any strict screening. Accordingly, more chances are offered to creators so that they can directly ask for public evaluation on their contents (works), and thus possible first-class works are prevented from being buried without being disclosed.

Moreover, in accordance with the present invention, a content disclosing support method of the present invention is characterized in comprising the steps of; registering created contents provided by unspecified number of content providers through a network, disclosing the registered contents to the public, permitting to access the contents on condition that a prescribed sum of money is paid, transmitting one or more content(s) to a user terminal through the network at a user's request, and counting the number of contents transmitted to the user terminal in order to calculate the amount of money to be paid to the content providers. Therefore, in accordance with the present invention, contents can be easily registered or disclosed without having to go through any strict screening. Accordingly, more chances are offered to creators so that they can directly ask for public evaluation on their contents (works), and thus possible first-class works are prevented from being buried without being disclosed.

In the content disclosing support method of the present invention, the amount of money to be paid to the content providers may be determined on the basis of a total count number of each content for a fixed period of time and a total count number of all contents for the fixed period of time. In this case, the amount of money to be paid to each content provider can be calculated properly. Thus, in such method where all contents of a server can be accessed and acquired by making certain payments, the amount of money to be paid to a content provider can be properly decided in proportion to the rate of hit numbers of each content.

In the content disclosing support method of the present invention, the user terminal may be composed of a cell phone terminal. In this case, since contents can be accessed and acquired by a cell phone terminal, the contents are to be accessed and acquired easily and cheaply. Thus, utilization of the content disclosing service is promoted and it is expected that contents are evaluated by a lot of users.

Furthermore, in accordance with the present invention, a recording medium recording a content disclosing support-control program is provided. The content disclosing support-control program comprises the steps of; registering created contents provided by unspecified number of content providers through a network, disclosing the registered contents to the public, permitting to access the contents on condition that a prescribed sum of money is paid, transmitting one or more content(s) to a user terminal through the network at a user's request, and counting the number of contents transmitted to the user terminal in order to calculate the amount of money to be paid to the content providers. Therefore, in accordance with the present invention, the contents can be easily registered or disclosed without going through any strict screening. Accordingly, more chances are offered to creators so that they can directly ask for public evaluation on their contents (works), and thus possible first-class works are prevented from being buried without being disclosed.

While the present invention has been described with reference to the particular illustrative embodiments, it is not to be restricted by these embodiments but only by the appended claims. It is to be appreciated that those skilled in the art can change or modify the embodiments without departing from the spirit and scope of the present invention.

What is claimed is:

1. A content disclosing support system comprising:
a content providing means for transmitting created contents provided by content provides through a network;
a registering means for registering contents provided by unspecified number of content providers through the content providing means;
a content disclosing means for making the contents registered by the content registering means available to the public;
a content acquiring means for acquiring one or more content(s) at a user's request while the user can access and view the contents disclosed by the content disclosing means through the network on condition that the user pays a prescribed amount of money; and
a counting means for counting a number of contents acquired by the content acquiring means to calculate the amount of money to be paid to the content providers.

2. A content disclosing support system comprising:
a registering means for registering created contents provided by unspecified number of content providers through a network;
a content disclosing means for making the contents registered by the content registering means available to the public;
a content transmitting means for transmitting one or more content(s) to a user terminal at a user's request while permitting the user to access and view the contents on condition that a prescribed amount of money is paid; and
a counting means for counting a number of contents transmitted by the content transmitting means to calculate the amount of money to be paid to the content providers.

3. The content disclosing support system as claimed in claim 1, comprising:
a count number memorizing means for recognizably memorizing the total count number of each content within a specified period of time and the total count number of all contents within the specified period of time, on the basis of the counting result given by the counting means;
a specified user number memorizing means for memorizing the number of users who have accepted payment of a set fee for the specified period of time; and
a payment amount deciding means for deciding the amount of money to be paid to each content provider by calculating as follows, divide a part of the total amount of collected money derived on the basis of a user number memorized in the specified user number memorizing means by the total count number of all contents, and multiply the calculated value by the total count number of each content.

4. The content disclosing support system as claimed in claim 2, comprising:
a count number memorizing means for recognizably memorizing the total count number of each content within a specified period of time and the total count number of all contents within the specified period of time, on the basis of the counting result given by the counting means;
a specified user number memorizing means for memorizing the number of users who have accepted payment of a set fee for the specified period of time; and
a payment amount deciding means for deciding the amount of money to be paid to each content provider by calculating as follows, divide a part of the total amount of collected money derived on the basis of a user number memorized in the specified user number memorizing means by the total count number of all contents, and multiply the calculated value by the total count number of each content.

5. The content disclosing support system as claimed in claim 1, wherein the contents are picture images taken by an image importing device.

6. The content disclosing support system as claimed in claim 2, wherein the contents are picture images taken by an image importing device.

7. The content disclosing support system as claimed in claim 4, wherein the contents are picture images taken by an image importing device.

8. The content disclosing support system as claimed in claim 1, wherein the contents are writings.

9. The content disclosing support system as claimed in claim 2, wherein the contents are writings.

10. The content disclosing support system as claimed in claim 4, wherein the contents are writings.

11. The content disclosing support system as claimed in claim 1, having a base station which transmits and receives information between subscriber terminals, wherein the content acquiring means transmits and receives information through the base station.

12. The content disclosing support system as claimed in claim 4, having a base station which transmits and receives information between subscriber terminals, wherein the content acquiring means transmits and receives information through the base station.

13. The content disclosing support system as claimed in claim 7, having a base station which transmits and receives information between subscriber terminals, wherein the content acquiring means transmits and receives information through the base station.

14. The content disclosing support system as claimed in claim 10, having a base station which transmits and receives information between subscriber terminals, wherein the content acquiring means transmits and receives information through the base station.

15. The content disclosing support system as claimed in claim 2, wherein the user terminal is composed of a cell phone terminal, and the content transmitting means transmits contents to the cell phone terminal.

16. The content disclosing support system as claimed in claim 4, wherein the user terminal is composed of a cell phone terminal, and the content transmitting means transmits contents to the cell phone terminal.

17. The content disclosing support system as claimed in claim 7, wherein the user terminal is composed of a cell phone terminal, and the content transmitting means transmits contents to the cell phone terminal.

18. The content disclosing support system as claimed in claim 10, wherein the user terminal is composed of a cell phone terminal, and the content transmitting means transmits contents to the cell phone terminal.

19. A content disclosing support method comprising the steps of:
transmitting created contents provided by content providers through a network;
registering contents provided by unspecified number of content providers;
disclosing the registered contents to the public;
accessing the disclosed contents through the network on condition that a prescribed amount of money is paid;
acquiring one or more content(s) at a user's request; and
counting the number of contents acquired for calculating the amount of money to be paid to the content providers.

20. A content disclosing support method comprising the steps of:
registering created contents provided by unspecified number of content providers through a network;
disclosing the registered contents to the public;
permitting to access the contents on condition that a prescribed amount of money is paid;
transmitting one or more content(s) to a user terminal through the network at a user's request; and
counting the number of contents transmitted to the user terminal in order to calculate the amount of money to be paid to the content providers.

21. The content disclosing support method as claimed in claim 19, wherein the amount of money to be paid to each content provider is determined on the basis of a count number of each content for a specified period of time and a total count number of all contents for the specified period of time.

22. The content disclosing support method as claimed in claim 20, wherein the amount of money to be paid to each content provider is determined on the basis of a count number of each content for a specified period of time and a total count number of all contents for the specified period of time.

23. The content disclosing support method as claimed in claim 19, wherein the user terminal is composed of a cell phone terminal.

24. The content disclosing support method as claimed in claim 20, wherein the user terminal is composed of a cell phone terminal.

25. The content disclosing support method as claimed in claim 22, wherein the user terminal is composed of a cell phone terminal.

26. A recording medium recording a content disclosing support-control program, the control program comprising the steps of:
registering created contents provided by unspecified number of content providers through a network;
disclosing the registered contents to the public;
permitting to access the contents on condition that a prescribed amount of money is paid;
transmitting one or more content(s) to a user terminal through the network at a user's request; and
counting the number of contents transmitted to the user terminal in order to calculate the amount of money to be paid to the content providers.
